(19) United States
(12) Patent Application Publication
(10) Pub. No.: US 2015/0023668 A1
(43) Pub. Date: Jan. 22, 2015

(54) LIGHT-BASED COMMUNICATIONS UTILIZING A GOSSIP NETWORK IN A VEHICLE/ROADWAY ENVIRONMENT

(71) Applicants: Jeremy Spaulding, Marblehead, MA (US); Karlin Jessen, Reading, MA (US); Mervyn Anthony, Waltham, MA (US)

(72) Inventors: Jeremy Spaulding, Marblehead, MA (US); Karlin Jessen, Reading, MA (US); Mervyn Anthony, Waltham, MA (US)

(73) Assignee: OSRAM SYLVANIA INC., Danvers, MA (US)

(21) Appl. No.: 13/947,181

(22) Filed: Jul. 22, 2013

(51) Int. Cl. H04B 10/112; G08C 23/04

(52) U.S. Cl. CPC H04B 10/1129; G08C 23/04
USPC 398/106; 398/118

(57) ABSTRACT

Techniques are disclosed that can be implemented as a light-based communications network exhibiting gossip network topology. In some embodiments, the network may include a plurality of mobile and/or fixed communicating nodes (peers) configured for light-based communications with one another. To that end, a node may host a transmitter (e.g., laser, LED, or other solid-state light source) configured to emit light-based communication signals and/or a receiver (e.g., a photosensor or other light-based data input device) configured to sense such signals. In some cases, the network may be used to propagate or otherwise disseminate strategic, tactical, and/or other vehicle-to-X (V2X) communications between vehicles and infrastructure in a vehicle/roadway environment. In some instances, the gossip topology may provide for relay and aggregation of information from node to node, improving reliability and availability of information propagated within the network. In some embodiments, the network may be autonomous (e.g., self-forming and/or self-serving).

### CROSS-REFERENCE TO RELATED APPLICATION

This application is related to U.S. patent application Ser. No. ______, (Attorney Docket No. 2013P01011US), filed on Jul. 22, 2013, which is herein incorporated by reference in its entirety.

### FIELD OF THE DISCLOSURE

The disclosure relates to light-based communication systems, and more particularly to light-based communications within a vehicle/roadway environment using gossip network topology.

### BACKGROUND

In a vehicle/roadway environment, current network topologies generally include cellular- and radio-based methods and traditional synchronized wireless networks. So-called vehicle-to-vehicle (V2V), vehicle-to-infrastructure (V2I), or vehicle-to-“X” (V2X) functionality can be used to transfer information within the vehicle/roadway environment. The information being transferred may be for a strategic communication (non-safety critical information) or a tactical communication (safety-critical and high-security information).

### BRIEF DESCRIPTION OF THE DRAWINGS

FIGS. 1A-1B illustrate radio-based wireless networks typically used for vehicle-to-X (V2X) communications in a vehicle/roadway environment.

FIG. 2A is a block diagram of a light-based communications system configured in accordance with an embodiment of the present disclosure.

FIG. 2B is a block diagram of a plurality of light-based communications systems operatively coupled with one another, in accordance with an embodiment of the present disclosure.

FIG. 3 is a flow diagram illustrating a process of light-based communication using a gossip network, in accordance with an embodiment of the present disclosure.

FIG. 4 illustrates an example light-based, peer-to-peer (P2P) communications network having a gossip-type network topology, in accordance with an embodiment of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

### DETAILED DESCRIPTION

Techniques are disclosed that can be implemented as a light-based communications network exhibiting gossip network topology. In some embodiments, the network may include a plurality of mobile and/or fixed communicating nodes (peers) configured for light-based communications with one another. To that end, a node may host a transmitter (e.g., laser, LED, or other solid-state light source) configured to emit light-based communication signals and/or a receiver (e.g., a photosensor or other light-based data input device) configured to sense such signals. In some cases, the network may be used to propagate or otherwise disseminate strategic, tactical, and/or other vehicle-to-X (V2X) communications between vehicles and infrastructure in a vehicle/roadway environment. In some instances, the gossip topology may provide for relay and aggregation of information from node to node, improving reliability and availability of information propagated within the network. In some embodiments, the network may be autonomous (e.g., self-forming and/or self-serving). Numerous configurations and variations will be apparent in light of this disclosure.

General Overview

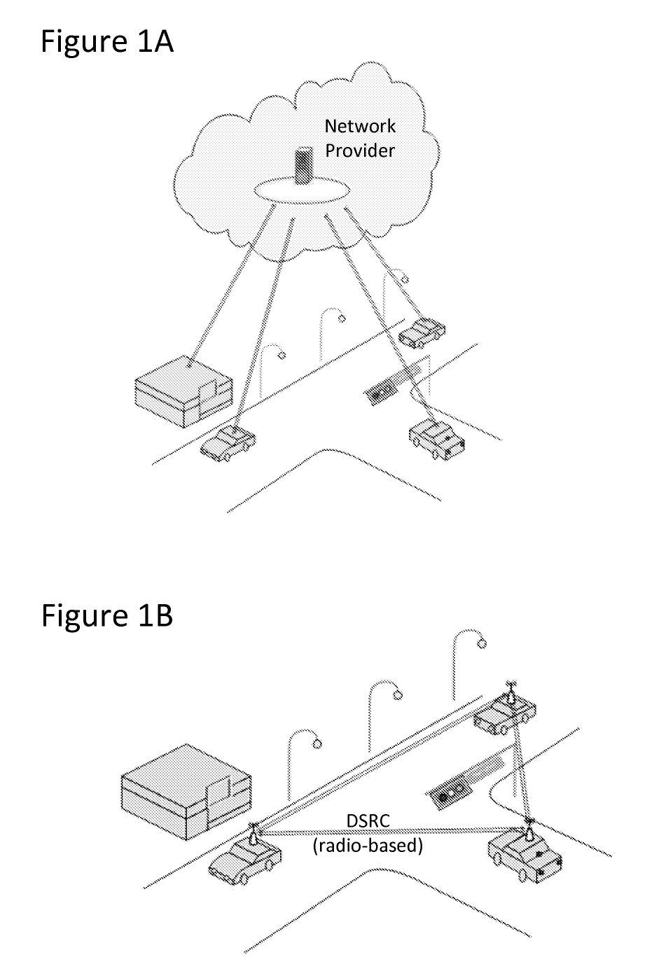

There are a number of non-trivial issues which complicate information dissemination within the vehicle/roadway environment. For example, current approaches to achieving vehicle-to-X (V2X) communications rely on existing radio-based wireless techniques. For instance, consider FIG. 1A, which illustrates a cellular phone-based wireless network typically used for V2X strategic communications in a vehicle/roadway environment, and FIG. 1B, which illustrates a Dedicated Short-Range Communications (DSRC) network typically used for V2X tactical communications in a vehicle/roadway environment. These existing radio-based communications techniques and their supporting synchronized mobile network topologies are limited in a number of ways. For example, existing radio-based communications systems are limited in terms of available bandwidth as shared/allocated based on system loading. Additionally, federal regulations limit radio-based communications in the vehicle/roadway environment to dedicated frequency spectra assigned, for example, by the Federal Communications Commission (FCC). Also, these existing approaches transfer data in an omnidirectional manner and thus do not resolve spatial information or transmit data to recipients in a particular direction. For instance, DSRC data is broadcast in a radio-based 360° field, and all recipients of information transmitted in this manner receive the same data. Therefore, the data is not tailored to the intended recipient, and significant post-processing, along with GPS location data, is required. Furthermore, existing communications network topologies rely on a relatively extensive dedicated radio-frequency infrastructure to serve the network and added specific hardware to form the network. The added cost and maintenance, particularly on the infrastructure side, can be prohibitive. Also, service provider limitations can contribute limitations. In a more general sense, latency, availability, and reliability concerns associated with existing radio-based V2X communications approaches may make such techniques inadequate, particularly with respect to safety concerns.

Thus, and in accordance with an embodiment of the present disclosure, techniques are disclosed that can be implemented as a light-based, peer-to-peer (P2P) communications network exhibiting a gossip network topology. In some embodiments, a network provided as described herein may include a plurality of mobile and/or fixed communicating nodes (peers) configured, for example, for light-based communications with one another. To that end, a given node may host one or more transmitters, such as a laser, light-emitting diode (LED), or other solid-state light source configured to emit light-based communication signals. Also, a given node may host one or more receivers, such as a photosensor or other light-based data input device configured to sense light-based communication signals. A given transmitter may be used to transmit data through a modulated (or otherwise modified) light spectrum to one or more receivers within line-of-sight, and those receivers may be used to collect that data. Note that a transmitter-receiver pair of a given node may be packaged as a transceiver.

As will be appreciated in light of this disclosure, within a vehicle/roadway environment, vehicles generally may interact with other vehicles and infrastructure within immediate proximity using light-based communication. Thus, in this sense, the vehicle/roadway environment can be thought of as having a dynamic P2P nature, where each vehicle or surrounding infrastructure element may serve as a peer. Within such an environment, peers may disseminate information (e.g., pertaining to brake lights, stop lights, turn indicators, adjacent vehicle speed, following vehicle speed, etc.) with one another in relative proximity.

The disclosed techniques may be utilized, for example, to provide a P2P network of mobile and/or fixed nodes which use light-based signals to propagate tactical communications and/or strategic communications within that network. As used herein, tactical communications generally may refer to time- and/or position-sensitive information, such as that pertaining to safety or security applications, for instance, in the context of a vehicle on the roadway. Some examples include: time-to-collision; emergency braking; acceleration; adaptive cruise control; proximity sensing; lane departure; blind spot detection; crash response; intersection signal violation; pedestrian detection; obstacle detection; and the like. As discussed herein, such tactical communications may be utilized in performing functions within the vehicle/roadway environment such as: intersection assist; left- and right-turn assist; advance warning of a vehicle braking ahead; forward- and rearward-collision warning; blind-spot/lane-change warning; do-not-pass warning; etc. Also, as used herein, strategic communications generally may refer to information which is not as time- or position-sensitive. Some examples include: social networking; mapping; traveler/tourist information; landmarks/waypoints; toll collection; traffic monitoring; weather monitoring; emergency vehicle notifications; disaster-related notifications; AMBER alerts; and the like. In a more general sense, and in accordance with some embodiments, the disclosed techniques can be used to propagate or otherwise disseminate strategic and/or tactical communications within a vehicle/roadway environment, for example, as vehicle-to-vehicle (V2V) communications, vehicle-to-infrastructure (V2I) communications, and/or other vehicle-to-X (V2X) communications.

Also, in accordance with some embodiments, a network provided as described herein may exhibit a gossip-type network topology. As used herein, the term ‘gossip’ generally may refer to a random, periodic, pair-wise interaction process that does not assume reliable communication, and a gossip-type network protocol may assume ‘idle talk’ or rumor between sources. Within a gossip-type network, a plurality of data sources can exchange packets of information quickly. The data sources within a gossip-type network can be generally characterized, for example, as aggregating (e.g., assemblers of information), rumor-mongering (e.g., passing information along), and/or data-repairing (e.g., correcting errors in information). Thus, in some embodiments, a gossip-type network provided as described herein may serve to combine information from multiple sources as it is relayed from node to node (e.g., peer to peer) within the network, thereby improving the reliability of the information in the aggregate, in some instances arriving at a high probability of receiving full information.

In some embodiments, a network provided using the disclosed techniques may be autonomous (e.g., self-forming and/or self-serving). That is, data propagation and processing may be realized, for example, without external input or decision making For instance, data received by a given node may be processed and an automatic action performed, or the data may be relayed to other available node(s) based on relative location or other factors. In some instances, such an autonomous network may be created dynamically within a vehicle/roadway environment. That is, in accordance with some embodiments, the network may form organically or spontaneously and may exist in periods of close proximity of peers and subsequently dissolve when peers leave the network or otherwise are no longer present. In some cases, the ability to share, aggregate, and relay information with surrounding vehicles in an organically-forming way may help involved vehicles to better predict and/or respond to a developing situation in the vehicle/roadway environment. Also, in some example cases, provision of a P2P network which is autonomous and which utilizes existing lighting infrastructure may provide for practical V2I communications in the vehicle/roadway environment.

In accordance with some embodiments, a network provided as described herein may be configured to utilize the line-of-sight nature of light-based communication sources and the improvement of communication with proximity. Some embodiments may be utilized, for example, for transfer of small to medium-sized data sets in situations not requiring synchronized data transfer. However, the present disclosure is not so limited, as in a more general sense, a network provided as described herein can be customized to accommodate the dynamic and fluid nature of independent vehicle mobility in the vehicle/roadway environment. Also, in accordance with some embodiments, a network provided as described herein may be utilized to transmit communications data with other potentially desirable information, such as position/location, signal strength, time-of-flight (TOF), and/or relative heading/direction data of the transmitter and/or receiver. From the combination of these data types, there exists the potential to derive additional information, for example, depending upon physical proximity of the sources, relative velocity/acceleration, and/or location within the field-of-view (FOV). Thus, and in accordance with an embodiment, the data transmitted can vary depending upon the transmitting source, the receiving source, the physical location of either, the present path of motion, and/or the proximity to another data source node. Some embodiments may utilize diversity across a broad spectrum or a multi-point approach (e.g., receivers in both forward lighting assemblies of a host vehicle), for example, to provide for discerning signals from noise and/or interference. In some embodiments, a network provided as described herein may be configured to transfer tactical communications nearly instantaneously (e.g., with low latency), which may be desirable, for example, in the case of vehicle-following and collision-warning systems in vehicles which are at speed and in close proximity with one another. Other suitable uses of the disclosed techniques will depend on a given application and will be apparent in light of this disclosure.

Some embodiments may provide for unique data transfer between nodes simultaneously with other unique data transmission, for example, based on distance, position, and/or heading information. In some cases, this may provide for a true P2P style of data transmission (e.g., to a particularly desired target node as opposed to all available nodes) based on multiple transmission factors. In some instances, this may realize benefits, for example, related to speed (e.g., which may be desirable for tactical or other time-sensitive communications), the omission of a service provider and thus avoidance of issues normally attendant therewith, and/or the omission of a central server.

Some embodiments can be used to provide low-latency information transfer between communicating nodes within the vehicle/roadway environment. Some embodiments may realize an improvement, for example, in the efficiency with which proximate vehicles interact in the vehicle/roadway environment, thereby improving traffic flow. Also, some embodiments may realize an improvement over existing mobile data networks, for example, in the V2V communications context with regard to transfer of data requiring low latency in close-proximity situations (e.g., such as dynamic vehicle information that may activate or otherwise influence real-time safety systems).

Some embodiments may provide for data transfer leveraging the large bandwidth available in the light-based communication spectrum, which is significantly larger than cell-based communication or DSRC spectrums, is generally not regulated or is otherwise subject to fewer restrictions/approvals, and does not require a central network provider to be involved for functionality. Some embodiments may provide for light-based data transfer over free space and thus may be capable of very high data transfer rates, for example, with no need for added/specialized infrastructure or complex data processing (e.g., for point-to-point communications) services or hardware. To this end, some embodiments may utilize elements/components which already may be available at a given node. For example, SSL sources already installed on a given vehicle or infrastructure element may be utilized as a transmitter and/or receiver. Alternatively, a given node can be retrofitted with desired transmitter and/or receiver componentry, which is relatively less expensive than radio-based wireless communications hardware. For example, optical transmitter and/or receiver componentry may be installed within the lighting housings of a given vehicle or infrastructure element (e.g., daytime-running lights, fog lamps, sidelights, headlights, taillights, third brake lights, street lights, lighted signage, etc.). Some embodiments may be implemented without need for additional expensive dedicated hardware and supporting infrastructure for transmitting, processing, and/or receiving of communications signals (e.g., unlike the system elements needed in the existing radio-based approaches, discussed above). Also, some embodiments may provide for true P2P interaction, for example, without need to establish a Wi-Fi -style synchronous connection or the associated network overhead.

System Architecture and Operation

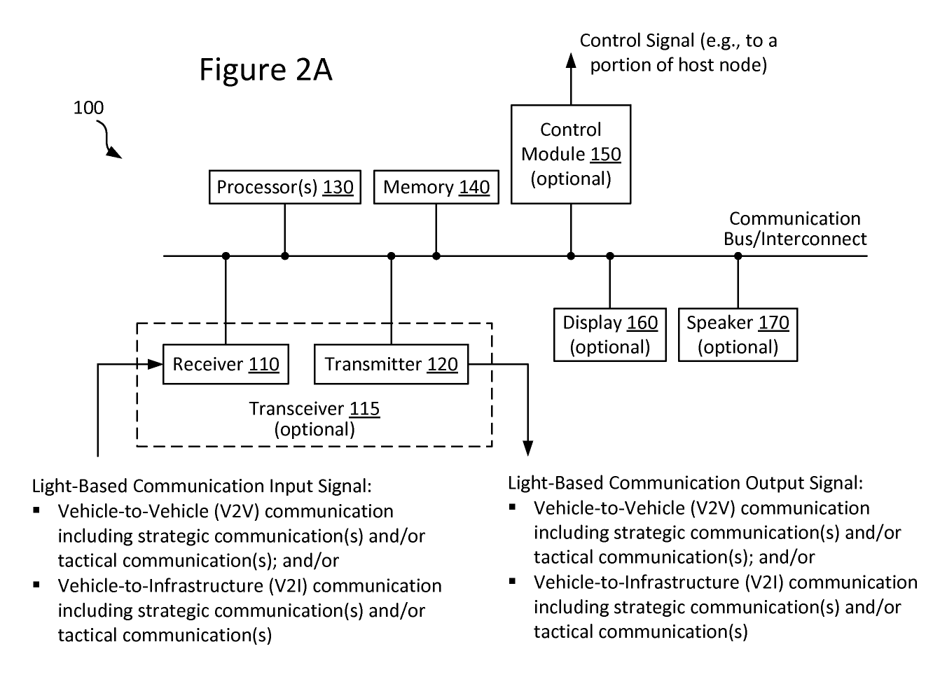

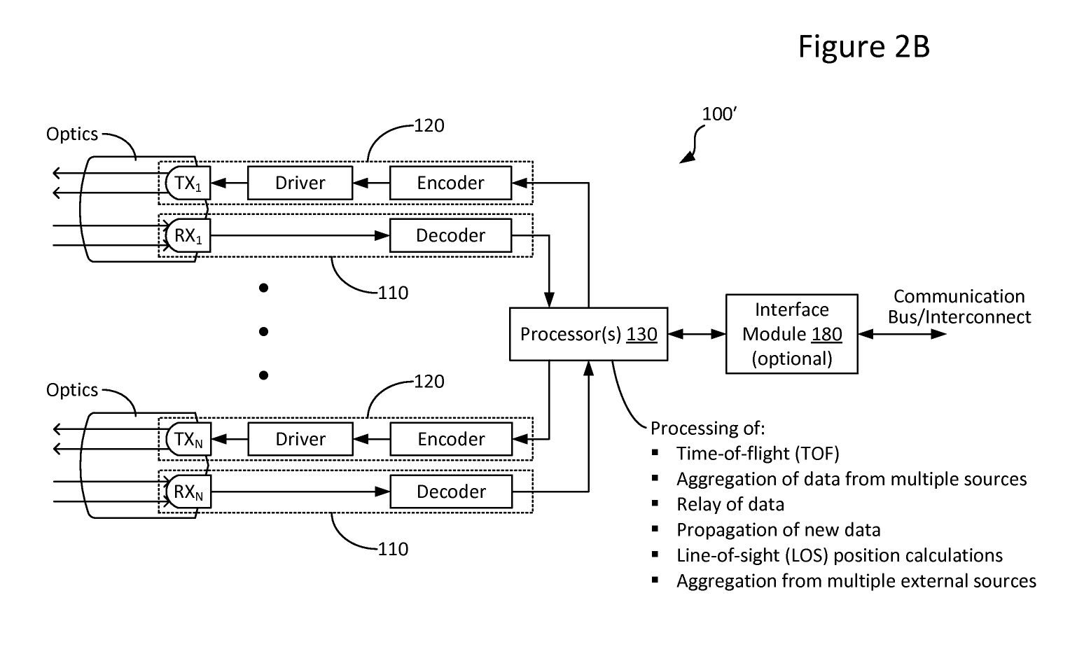

FIG. 2A is a block diagram of a light-based communications system 100 configured in accordance with an embodiment of the present disclosure. As discussed herein, system 100 may be configured for light-based communications with one or more other system(s) 100, for example, within line-of-sight. To that end, system 100 may include a number of modules operatively coupled with one another, including, for example, a receiver module 110, a transmitter module 120, processor(s) 130, and memory 140. As will be appreciated in light of this disclosure, in some cases, a receiver module 110 and a transmitter module 120 optionally may be combined into a transceiver module 115 having both receiver and transmitter capabilities. In some embodiments, system 100 optionally may include additional modules, such as, but not limited to, a control module 150, a display 160, and/or a speaker 170. In some instances, a plurality of systems 100 (e.g., a quantity ranging from 1-N) may be operatively coupled with one another to provide a system 100′, such as is shown in FIG. 2B. In some such instances, it may be desirable to provide an optional interface module 180, for example, to assist with communication with other modules along the communication bus/interconnect. Also, as discussed below, system 100 can be integrated, in part or in whole: (1) on a mobile communicating node, such as a vehicle; and/or (2) on a fixed communicating node, such as a traffic signal, a street light, illuminated signage on a building, etc. In some cases, system 100 can be provided with a distributed architecture and thus may have some degree of functional distributedness. Numerous suitable configurations will be apparent in light of this disclosure.

In accordance with some embodiments, receiver 110 may be a photosensor or other light-based data input device configured to receive visible and/or non-visible light-based communication input signals. To that end, receiver 110 can be configured to sense wavelength(s) of interest from any spectral band (e.g., visible spectral band, infrared spectral band, ultraviolet spectral band, etc.), as desired for a given target application or end-use. Also, in some instances, receiver 110 may include one or more decoders, as desired. In accordance with an embodiment, receiver 110 can be configured to receive light-based communication signals from a given source from one or more directions (e.g., such as from a transmitter 120 of a second system 100 within line-of-sight of the receiver 110 of the first system 100). In some cases, and in accordance with an embodiment, receiver 110 can be a photosensor with which the host node may be retrofitted. In some embodiments, receiver 110 may be a SSL source device (e.g., such as any of the example devices discussed below with reference to transmitter 120) in its unpowered or off state.

If the host node is a vehicle, for example, then receiver 110 may be integrated with the host vehicle, in accordance with some embodiments. For example, receiver 110 may be installed within one or more of the lighting housings (e.g., daytime-running lights, fog lamps, sidelights, headlights, taillights, third brake lights, etc.) of the host vehicle. Other suitable configurations for receiver 110 will depend on a given application and will be apparent in light of this disclosure.

In accordance with some embodiments, transmitter 120 may be a solid-state light (SSL) source or other light-based output device configured to output visible and/or non-visible light-based communication signals. To that end, transmitter 120 can be configured to emit wavelength(s) of interest from any spectral band (e.g., visible spectral band, infrared spectral band, ultraviolet spectral band, etc.), as desired for a given target application or end-use. For example, transmitter 120 may be a SSL device, such as, but not limited to, a light-emitting diode (LED), an organic light-emitting diode (OLED), a polymer light-emitting diode (PLED), a solid-state laser, and/or any combination thereof. In some cases, transmitter 120 may be, for example, a converted SSL device (e.g., phosphor over blue to provide a white LED). Also, in some instances, transmitter 120 may include one or more encoders and drivers, as desired. In accordance with an embodiment, transmitter 120 can be configured to output light-based communication signals in one or more directions (e.g., such as in the direction of a receiver 110 of a second system 100 within line-of-sight of the transmitter 120 of the first system 100). In some embodiments, transmitter 120 may include an array of SSL sources. In some cases, and in accordance with an embodiment, transmitter 120 can be or otherwise utilize, in part or in whole, a SSL source which is already available on the host node. In some other cases, and in accordance with an embodiment, transmitter 120 can be a SSL source with which the host node may be retrofitted. In some instances, use of both existing SSL sources and retrofitted componentry may be provided.

If the host node is a vehicle, for example, then transmitter 120 may be integrated with the host vehicle, in accordance with some embodiments. For example, transmitter 120 may be installed within any one or more of the lighting housings noted above with reference to receiver 110. In a more general sense, transmitter 120 may utilize any of a wide variety of SSL techniques and components. Other suitable configurations for transmitter 120 will depend on a given application and will be apparent in light of this disclosure.

In accordance with some embodiments, system 100 may include one or more processor(s) 130 configured to locally control functionality of one or more portions of system 100. For example, processor(s) 130 may be configured to: (1) process light-based communications signals received by a receiver 110; and/or (2) generate light-based communications signals to be emitted by a transmitter 120. A given processor 130 may be configured to perform any of a wide variety of functions, such as: calculating time-of-flight (TOF); aggregating data from multiple sources; relaying data; propagating new data; calculating line-of-sight (LOS) position; and/or aggregating data from multiple external sources. Also, in some cases, processor(s) 130 can be configured to determine whether and how to convey the information to an observer (e.g., such as by an operatively coupled display 160 and/or speaker 170). For instance, in some cases in which a display 160, discussed below, is optionally included, processor(s) 130 can be configured to decode and/or render images and graphics for display on a given display 160. In some cases in which a speaker 170, discussed below, is optionally included, processor(s) 130 can be configured to select and/or decode a particular tone or other sound to be emitted by speaker 170. In addition, processor(s) 130 may be configured to access and execute any of the modules stored within memory 140, discussed below. Other suitable configurations and capabilities of processor(s) 130 will depend on a given application and will be apparent in light of this disclosure.

In accordance with some embodiments, memory 140 can be configured to store system data on a temporary or permanent basis and may include volatile and/or non-volatile memory to that end. In some cases, memory 140 may be configured to store light-based communications data received and/or transmitted by system 100. Also, in some cases, memory 140 may be configured to store outbound light-based communications data (e.g., outbound light-based communications not yet transmitted). Furthermore, in some instances, memory 140 may be configured to store host node profile data (e.g., preferences/settings related to system 100 for the host node; a unique node ID for light-based communications purposes; etc.). Other types of data which it may be desirable to store within memory 140 will depend on a given application and will be apparent in light of this disclosure.

Also, memory 140 can include any number of modules stored therein that can be accessed and executed, for example, by the processor(s) 130. For example, in some instances, memory 140 may include a sound database module from which tones or other sounds to be emitted by a speaker 170 (when optionally included) may be retrieved. In some instances, memory 140 may include a data security module to encrypt/decrypt light-based communication signals received and/or transmitted by system 100. Other suitable modules which it may be desirable to store within memory 140 will depend on a given application and will be apparent in light of this disclosure.

The modules of memory 140 can be implemented, for example, in any suitable programming language, such as C, C++, objective C, JavaScript, custom or proprietary instruction sets, etc. The modules can be encoded, for example, on a machine-readable medium that, when executed by the processor, carries out the functionality of system 100, in part or in whole. The computer-readable medium may be any suitable non-transitory computing device memory that includes executable instructions, such as: a hard drive; a compact disk; a memory stick; and/or any combination thereof. Other embodiments may be implemented, for instance, with gate-level logic, an application-specific integrated circuit (ASIC) or chip set, or other such purpose-built logic. Some embodiments can be implemented with a microcontroller having input/output capability (e.g., inputs for receiving user inputs; outputs for directing other components) and a number of embedded routines for carrying out the system functionality. In a more general sense, the functional modules of memory 140 can be implemented in hardware, software, and/or firmware, as desired.

As previously noted, in some embodiments, system 100 optionally may include a control module 150. Control module 150 may be configured to output a control signal which may be used, for example, in controlling the operation of a portion of the host node. For example, if the host node is a vehicle, control module 150 may output a control signal to a given electronic control unit of the host vehicle, such as, but not limited to: the speed/cruise control unit; the brake control unit; the airbag control unit; etc. In a more general sense, control module 150 may output a signal to some portion of the host vehicle so as to cause a change in the operation of that receiving portion and thus effectuate a change in the operation of the host vehicle (e.g., for roadway safety, for fuel efficiency, etc.). Other suitable configurations and capabilities for optional control module 150 will depend on a given application and will be apparent in light of this disclosure.

Also, as previously noted, system 100 optionally may be configured to provide notifications or other feedback to an observer, in some embodiments. In some cases, system 100 may be configured to indicate that it has received and/or transmitted light-based communications data. In some instances, system 100 may be configured to indicate or otherwise provide an alert/notification to the observer that a given piece of received and/or transmitted communications data is particularly important or urgent. In some cases, notifications/alerts such as advance warning of a vehicle braking ahead, forward- and rearward-collision warning, blind-spot/lane-change warning, do-not-pass warning, etc., may be provided. In some cases, notification/feedback pertaining to a warning, alert, or other emergency notice (e.g., news/current events, traffic patterns, severe weather, emergency conditions/events, an evacuation procedure, etc.) may be provided by system 100. As will be appreciated, and in accordance with some embodiments, these and other notifications and feedback types may be utilized, for example, in performing functions within the vehicle/roadway environment such as, but not limited to, intersection assist, left- and right-turn assist, lane changes, detours/rerouting, etc. Other suitable forms of notifications/feedback will depend on a given application and will be apparent in light of this disclosure.

In accordance with some embodiments, system 100 may include or otherwise be configured to communicate with one or more displays 160 to provide visual notifications/feedback to an observer. A given display 160 may be configured such that, upon receipt and/or transmission of data by system 100, it displays a message, icon, color, or other visual indicator which conveys that data to the observer. To that end, a given display 160 can be any suitable display screen or other device on which images, video, text, or other visual content can be displayed, as will be apparent in light of this disclosure. In some cases, a given display 160 may be caused to display text, an image, a video, or other visual cue regarding the importance/urgency of a given light-based communication received or transmitted by system 100. If the host node is a vehicle, for example, then a given display 160 may be integrated with the host vehicle, in some embodiments. For example, display 160 may be part of the dashboard instrument panel or rearview mirror or may be an on-board display screen provided in the center console of the vehicle. In some other embodiments, a given display 160 may be a stand-alone component configured to communicate with one or more other portions of system 100 using any suitable wired (e.g., Universal Serial Bus or USB, Ethernet, FireWire, etc.) and/or wireless (e.g., Wi-Fi®, Bluetooth®, etc.) communications. Other suitable configurations and capabilities for optional display 160 will depend on a given application and will be apparent in light of this disclosure.

In accordance with some embodiments, system 100 may include or otherwise be configured to communicate with one or more speakers 170 to provide aural notifications/feedback to an observer. A given speaker 170 may be configured such that, upon receipt and/or transmission of data by system 100, it emits a tone, music, recorded vocals, or other aural indicator which conveys the data to the observer. To that end, a given speaker 170 can be any suitable speaker or other device from which sound can be transmitted, as will be apparent in light of this disclosure. In some cases, a given speaker 170 may be caused to vary the type, pattern, and/or intensity of sound emitted thereby to signify the importance/urgency of a given light-based communication received or transmitted by system 100. If the host node is a vehicle, for example, then a given speaker 170 may be integrated with the host vehicle, in some embodiments. For example, speaker 170 may be part of the audio system provided in the vehicle. In some other embodiments, a given speaker 170 may be a stand-alone component configured to communicate with one or more other portions of system 100 using any of the wired and/or wireless communications noted above with respect to optional display 160.

As will be appreciated in light of this disclosure, in some cases, system 100 may be configured to employ multiple types of notification/feedback simultaneously. For example, display 160 may display a received communications message while speaker 170 emits a recorded vocal of that message. Numerous suitable techniques for providing notifications/feedback will be apparent in light of this disclosure.

Methodology

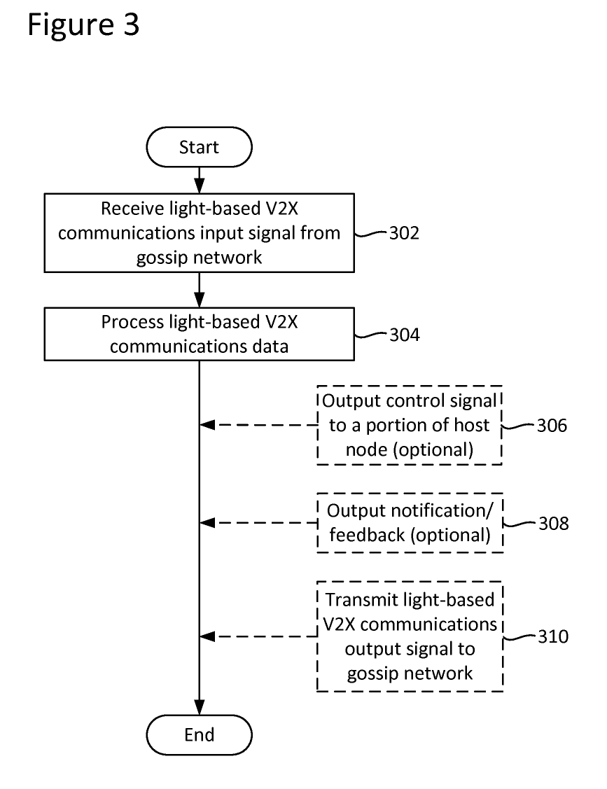

FIG. 3 is a flow diagram illustrating a process of light-based communication using a gossip network, in accordance with an embodiment of the present disclosure. The flow may begin as in block 302 with receiving a light-based V2X communications input signal from a gossip network. As discussed above, receiver 110 (or transceiver 115, if provided) may be configured to receive the light-based V2X communications input signal, in accordance with an embodiment. The input signal may come from any of a number of sources within the gossip network, such as, for example, a transmitter 120 of another system 100 (e.g., as hosted by another mobile or fixed communicating node within the gossip network) within line-of-sight of that receiver 110. In some instances, the input signal may comprise, in part or in whole, one or more strategic communications and/or tactical communications. In some such instances, the input signal may comprise an aggregated or otherwise relayed set of strategic and/or tactical V2X communications from one or more nodes within the gossip network.

The flow may continue as in block 304 with processing the light-based V2X communications data of the received signal. As discussed above, one or more processors 130 may be configured to operate to that end. Processing of the light-based V2X communications data may entail, for example: (1) interpreting one or more strategic communications and/or tactical communications present within the light-based V2X communications input signal; and/or (2) generating a light-based V2X communications output signal having one or more strategic communications and/or tactical communications present therein. In some instances, processor(s) 130 may serve to aggregate and/or relay a given strategic or tactical communication. In some cases, processing further may entail determining whether and how to convey the received V2X communications data to an observer (e.g., such as by an operatively coupled display 160 and/or speaker 170). In some cases in which a display 160 is included, processor(s) 130 can be configured to decode and/or render the image, video, message, icon, or other visual indicator to be displayed by display 160. In some cases in which a speaker 170 is included, processor(s) 130 can be configured to select and/or decode the tone, music, recorded vocals, or other aural indicator to be emitted by speaker 170.

In some cases, the flow optionally may continue as in block 306 with outputting a control signal to a portion of the host node. As discussed above, when included with system 100, optional control module 150 may be configured to operate to that end, in accordance with an embodiment. As previously noted, the control signal can be used, for example, to control the operation of some portion(s) of the host node. If the host node is a vehicle, for example, the control signal may be provided to a given electronic control unit thereof (e.g., speed/cruise control unit, brake control unit, airbag control unit, etc.). Other suitable uses of the one or more optional control signals will depend on a given application and will be apparent in light of this disclosure.

In some cases, the flow optionally may continue as in block 308 with outputting a notification or other feedback. As discussed above, when included with system 100, an optional display 160 and/or speaker 170 may be configured to operate to that end, in accordance with some embodiments. In some cases in which a display 160 is included, an image, video, message, icon, or other visual indicator which conveys the V2X communications data may be provided. In some cases in which a speaker 170 is included, a tone, music, recorded vocals, or other aural indicator which conveys the V2X communications data may be provided. In some instances, visual and aural notifications/feedback may be provided simultaneously by system 100 to manifest an appropriate or otherwise desired notification, alert, or feedback.

In some cases, the flow optionally may continue as in block 310 with transmitting a light-based V2X communications output signal to the gossip network. As discussed above, transmitter 120 (or transceiver 115, if provided) may be configured to emit the light-based V2X communications output signal, in accordance with an embodiment. The output signal may be directed, for example, to a receiver 110 of another system 100 (e.g., as hosted by another mobile or fixed communicating node within the gossip network) within line-of-sight of that transmitter 120. In some instances, the output signal may comprise, in part or in whole, one or more strategic communications and/or tactical communications. In some such instances, the output signal may comprise an aggregated or otherwise relayed set of strategic and/or tactical V2X communications from one or more nodes within the gossip network.

Numerous variations on this process will be apparent in light of this disclosure. As will be appreciated, and in accordance with an embodiment, each of the functional boxes (e.g., 302, 304, 306, 308, and 310) shown in FIG. 3 can be implemented, for example, as a module or sub-module that, when executed by one or more processors or otherwise operated, causes the associated functionality as described herein to be carried out. The modules/sub-modules may be implemented, for instance, in software (e.g., executable instructions stored on one or more computer-readable media), firmware (e.g., embedded routines of a microcontroller or other device which may have input/output capacity for soliciting input from a user and providing responses to user requests), and/or hardware (e.g., gate-level logic, field-programmable gate array, purpose-built silicon, etc.).

Network Topology and Operation

As previously noted, system 100 may be hosted, in part or in whole, by a given fixed or mobile communicating node. Also, as previously discussed, a given system 100 may be configured to communicate with one or more other systems 100 using light-based communications signals. Thus, and in accordance with some embodiments, a plurality of systems 100 hosted by a plurality of fixed and/or mobile communicating nodes may be capable of communicating with one another, for example, to provide a light-based communications network. In some cases, such a network may function, for example, as a light-based data network exhibiting a gossip-type network topology.

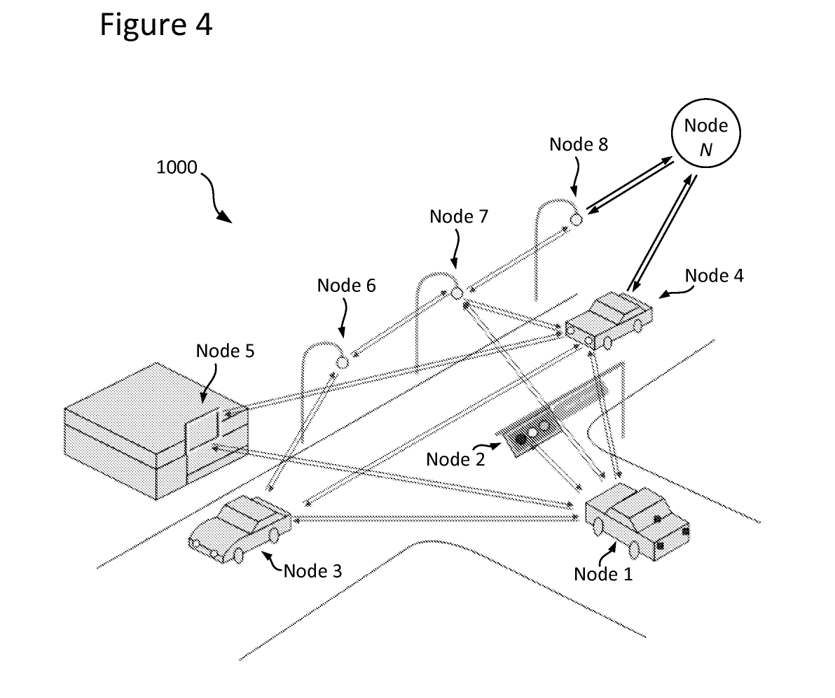

FIG. 4 illustrates an example light-based peer-to-peer (P2P) communications network 1000 having a gossip-type network topology, in accordance with an embodiment of the present disclosure. As can be seen, network 1000 may include any quantity of nodes (Nodes 1-N). A given node may be, for example, a mobile communicating node (e.g., such as a vehicle) or a fixed communicating node (e.g., such as a traffic signal, a street light, electroluminescent signage or other light source on a building, etc.). Each node that hosts system 100 (in part or in whole) may be capable of sending and/or receiving light-based communications data.

A given light-based communications signal (e.g., whether input to a receiver 110 or output by a transmitter 120), may comprise, for example: (1) one or more strategic communications; and/or (2) one or more tactical communications. In some cases, a given light-based communications signal may comprise an aggregated or otherwise relayed set of strategic and/or tactical communications. In a more general sense, and in accordance with an embodiment, a given light-based communication signal may be a V2V communication, a V2I communication, or any other V2X communication. In some instances, a given light-based communication signal may include other information, such as position/location, signal strength, time-of-flight (TOF), and/or relative heading/direction data of the transmitter 120 and/or receiver 110, as previously discussed. Other suitable data contents for a given light-based communications signal will depend on a given application and will be apparent in light of this disclosure.

As can be seen, network 1000 may propagate or otherwise disseminate information over its gossip network topology, in accordance with some embodiments. Such a P2P gossip network topology may overlay the generally P2P vehicle/roadway environment. The shared internal network of receivers 110 and transmitters 120 of the mobile communicating nodes can communicate, for example, not only with one another, but also with the fixed communicating nodes in the external environment. For instance, a given transmitter 120 (or transceiver 115, if provided) can transmit V2X communications data in any desired heading or direction to one or more receivers 110. A given receiver 110 (or transceiver 115, if provided) can collect V2X communications data from a variety of directions and as output by any number of transmitters 120. As the communications data propagates through network 1000, each contributing mobile or fixed communication node may feed light-based communications data into the network 1000. In some cases, this may help to improve the reliability of the communications data in the aggregate (e.g., by serving to combine data from multiple source nodes to arrive at a high probability of receiving full or otherwise sufficiently complete information) and help with load balancing across the network 1000.

In some embodiments, light-based communication within network 1000 may be provided between nodes in immediate proximity with one another. That is, network 1000 may be configured such that P2P connectivity exists locally and communication does not occur with random, far away nodes. As will be appreciated in light of this disclosure, this type of P2P communications approach may be utilized, for example, with a vehicle/roadway environment, where vehicles normally are in relatively close proximity with one another and with traffic signals, street lights, illuminated signs, etc., in that environment. Thus, in this sense, network 1000 may exhibit a biased gossip-type topology (e.g., as opposed to a purely random peer-selection scheme) in which light-based communication occurs between communicating nodes which are sufficiently proximate one another (e.g., a transmitter 120 of a first system 100 communicates with the receiver 110 of a second system 100 which is sufficiently nearby and within the line-of-sight of the transmitter 120 of the first system 100).

In some embodiments, network 1000 may be configured to be autonomous (e.g., self-forming and/or self-serving). That is, data propagation and processing within network 1000 may be realized, for example, without external input or decision making, in some embodiments. For instance, data received by a given node may be processed and an automatic action performed, or the data may be relayed to other available mobile and/or fixed node(s) based on relative location or other factors. In some instances, such an autonomous network 1000 may be created dynamically within a vehicle/roadway environment. That is, in accordance with some embodiments, the autonomous network 1000 may form organically or spontaneously and may exist in periods of close proximity of peers and dissolve when peers leave the network 1000 or otherwise are no longer present.

Numerous embodiments will be apparent in light of this disclosure. One example embodiment of the present invention provides a method of light-based communication using a gossip network within a vehicle/roadway environment, the method including: receiving a first light-based communication signal from the gossip network at a first node of the gossip network; and processing the first light-based communication signal at the first node of the gossip network. In some cases, the first light-based communication signal comprises a vehicle-to-X (V2X) communication. In some such cases, the V2X communication comprises a vehicle-to-vehicle (V2V) communication including at least one of tactical communication data and/or strategic communication data. In some other cases, the V2X communication comprises a vehicle-to-infrastructure (V2I) communication including at least one of tactical communication data and/or strategic communication data. In some instances, the first light-based communication signal includes data pertaining to at least one of a position of the first node relative to a second node, a location of the first node within the gossip network, a strength of the first light-based communication signal, a time-of-flight (TOF) of the first light-based communication signal, and/or a heading of the first node relative to a second node. In some cases, after processing the first light-based communication signal at the first node of the gossip network, the method further includes: relaying the first light-based communication signal from the first node of the gossip network to a second node of the gossip network. In some cases, after processing the first light-based communication signal at the first node of the gossip network, the method further includes: transmitting a second light-based communication signal from the first node of the gossip network to a second node of the gossip network, wherein the second light-based communication signal is inclusive of the first light-based communication signal and additional data received from the gossip network. In some instances, the first node comprises a vehicle, and, after processing the first light-based communication signal at the first node of the gossip network, the method further includes: outputting a control signal to control a vehicle function. In some cases, after processing the first light-based communication signal at the first node of the gossip network, the method further includes: outputting a notification to at least one of a display hosted by the first node and/or a speaker hosted by the first node. In some instances, receiving and processing the first light-based communication signal at the first node occurs autonomously.

Another example embodiment of the present invention provides a light-based communications system including: a receiver configured to sense incoming light-based vehicle-to-X (V2X) communication signals from a gossip network; a transmitter configured to emit light-based V2X communication signals to the gossip network; and a processor configured to at least one of process incoming light-based communication signals sensed by the receiver and/or process light-based communication signals to be emitted by the transmitter. In some cases, the receiver comprises a photosensor and the transmitter comprises at least one of a solid-state laser and/or one or more light-emitting diodes (LEDs). In some cases, the system further includes a control module configured to output a control signal associated with a vehicle function. In some instances, the system further includes at least one of a display configured to display a visual notification provided by the processor and/or a speaker configured to emit an aural notification provided by the processor. In some cases, a vehicle including the system is provided.

Another example embodiment of the present invention provides a light-based vehicle-to-X (V2X) communications system having a gossip network topology, the system including: a first node configured to output a light-based V2X communication; and a second node configured to receive and process the light-based V2X communication; wherein at least one of the first node and/or second node comprises a fixed node on a roadway. In some cases, at least one of the first node and/or second node comprises a traffic signal, a street light, or an electroluminescent sign. In some cases, one of the first node or second node comprises a vehicle. In some instances, the V2X communication comprises a vehicle-to-vehicle (V2V) communication including at least one of tactical communication data and/or strategic communication data. In some instances, the V2X communication comprises a vehicle-to-infrastructure (V2I) communication including at least one of tactical communication data and/or strategic communication data. In some cases, the V2X communication comprises at least one of tactical communication data and/or strategic communication data and further comprises data pertaining to at least one of a position of the first node relative to the second node, a location of the first node, a strength of the light-based communication signal, a time-of-flight (TOF) of the light-based communication signal, and/or a heading of the first node relative to the second node. In some instances, output of the light-based communication by the first node is provided by a transmitter hosted by the first node, and receipt of the light-based communication by the second node is provided by a receiver hosted by the second node. In some cases, the receiver comprises a photosensor and the transmitter comprises at least one of a solid-state laser and/or one or more light-emitting diodes (LEDs).

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method of light-based communication using a gossip network within a vehicle/roadway environment, the method comprising:
receiving a first light-based communication signal from the gossip network at a first node of the gossip network; and
processing the first light-based communication signal at the first node of the gossip network.

2. The method of claim 1, wherein the first light-based communication signal comprises a vehicle-to-X (V2X) communication.

3. The method of claim 2, wherein the V2X communication comprises a vehicle-to-vehicle (V2V) communication including at least one of tactical communication data and/or strategic communication data.

4. The method of claim 2, wherein the V2X communication comprises a vehicle-to-infrastructure (V2I) communication including at least one of tactical communication data and/or strategic communication data.

5. The method of claim 1, wherein the first light-based communication signal includes data pertaining to at least one of a position of the first node relative to a second node, a location of the first node within the gossip network, a strength of the first light-based communication signal, a time-of-flight (TOF) of the first light-based communication signal, and/or a heading of the first node relative to a second node.

6. The method of claim 1, wherein after processing the first light-based communication signal at the first node of the gossip network, the method further comprises:
relaying the first light-based communication signal from the first node of the gossip network to a second node of the gossip network.

7. The method of claim 1, wherein after processing the first light-based communication signal at the first node of the gossip network, the method further comprises:
transmitting a second light-based communication signal from the first node of the gossip network to a second node of the gossip network, wherein the second light-based communication signal is inclusive of the first light-based communication signal and additional data received from the gossip network.

8. The method of claim 1, wherein the first node comprises a vehicle, and wherein after processing the first light-based communication signal at the first node of the gossip network, the method further comprises:
outputting a control signal to control a vehicle function.

9. The method of claim 1, wherein after processing the first light-based communication signal at the first node of the gossip network, the method further comprises:
outputting a notification to at least one of a display hosted by the first node and/or a speaker hosted by the first node.

10. The method of claim 1, wherein receiving and processing the first light-based communication signal at the first node occurs autonomously.

11. A light-based communications system comprising:
a receiver configured to sense incoming light-based vehicle-to-X (V2X) communication signals from a gossip network;
a transmitter configured to emit light-based V2X communication signals to the gossip network; and
a processor configured to at least one of process incoming light-based communication signals sensed by the receiver and/or process light-based communication signals to be emitted by the transmitter.

12. The system of claim 11, wherein the receiver comprises a photosensor and the transmitter comprises at least one of a solid-state laser and/or one or more light-emitting diodes (LEDs).

13. The system of claim 11 further comprising a control module configured to output a control signal associated with a vehicle function.

14. The system of claim 11 further comprising at least one of a display configured to display a visual notification provided by the processor and/or a speaker configured to emit an aural notification provided by the processor.

15. A vehicle comprising the system of claim 11.

16. A light-based vehicle-to-X (V2X) communications system having a gossip network topology, the system comprising:
a first node configured to output a light-based V2X communication; and
a second node configured to receive and process the light-based V2X communication;
wherein at least one of the first node and/or second node comprises a fixed node on a roadway.

17. The system of claim 16, wherein at least one of the first node and/or second node comprises a traffic signal, a street light, or an electroluminescent sign.

18. The system of claim 16, wherein one of the first node or second node comprises a vehicle.

19. The system of claim 16, wherein the V2X communication comprises a vehicle-to-vehicle (V2V) communication including at least one of tactical communication data and/or strategic communication data.

20. The system of claim 16, wherein the V2X communication comprises a vehicle-to-infrastructure (V2I) communication including at least one of tactical communication data and/or strategic communication data.

21. The system of claim 16, wherein the V2X communication comprises at least one of tactical communication data and/or strategic communication data and further comprises data pertaining to at least one of a position of the first node relative to the second node, a location of the first node, a strength of the light-based communication signal, a time-of-flight (TOF) of the light-based communication signal, and/or a heading of the first node relative to the second node.

22. The system of claim 16, wherein output of the light-based communication by the first node is provided by a transmitter hosted by the first node, and wherein receipt of the light-based communication by the second node is provided by a receiver hosted by the second node.

23. The system of claim 22, wherein the receiver comprises a photosensor and the transmitter comprises at least one of a solid-state laser and/or one or more light-emitting diodes (LEDs).
